(19) United States
(12) Patent Application Publication
(10) Pub. No.: US 2026/0350206 A1
(43) Pub. Date: Nov. 5, 2026

(54) SYSTEMS AND METHODS FOR GRAPH-ANCHORED ATTRIBUTE-BASED ACCESS CONTROL

(71) Applicant: The Dot Net Factory, LLC., Dublin, OH (US)

(72) Inventor: Patrick Henry PARKER, Sarasota, FL (US)

(73) Assignee: The Dot Net Factory, LLC., Dublin, OH (US)

(21) Appl. No.: 19/410,761

(22) Filed: Dec. 5, 2025

Related U.S. Application Data
(60) Provisional application No. 63/798,201, filed on May 1, 2025.

(51) Int. Cl. G06F 21/62; G06F 12/0811; G06F 12/0891; G06F 12/123; G06F 16/901

(52) U.S. Cl. CPC G06F 21/6227; G06F 12/0811; G06F 12/0891; G06F 12/123; G06F 16/9024; G06F 2221/2141

(57) ABSTRACT

Systems and methods for access control are provided. The method involves embedding one or more policy nodes within a graph database, where each policy node includes a pointer to at least one external attribute-based access control (ABAC) document. Upon receiving an access request, the method includes traversing the graph database to identify applicable policy nodes based on a set of relationship edges. The method further includes retrieving the external ABAC document associated with the identified policy nodes from an external database via the pointer. The identified policy nodes are then evaluated to resolve any conflicts. Based on this evaluation, an access decision is generated in response to the access request.

### CROSS-REFERENCE TO RELATED APPLICATIONS

This application claims priority to and the benefit of the provisional patent application titled “SYSTEMS AND METHODS FOR GRAPH-ANCHORED ATTRIBUTE-BASED ACCESS CONTROL”, application No. 63/798201, filed in the United States Patent and Trademark Office on May 1, 2025. The specification of the above-referenced patent application is incorporated herein by reference in its entirety.

### TECHNICAL FIELD OF THE DISCLOSURE

The present disclosure relates to computer-based access control and authorization.

### BACKGROUND

Current access control policy procedures in information systems include several challenges that can impact the accuracy and reliability of authorization decisions. These challenges include the presence of outdated or conflicting policies, which can obscure true access requirements and complicate decision-making. The complex and dynamic nature of organizational structures can lead to multiple roles and permissions, making it difficult to accurately identify access rights. Traditional access control policy procedures may struggle to adapt to the rapid changes in organizational structures and user roles, leading to inconsistencies and gaps in policy enforcement. Additionally, the computational intensity of these methods can result in significant resource consumption and longer processing times, limiting the scalability and efficiency of these techniques.

Despite advancements in access control policy techniques, current methods are still ineffective in achieving optimal results. Accordingly, there is a need to improve access control policies to overcome existing technological challenges by implementing enhancements such as: increasing the reliability of authorization decisions, reducing inefficiencies associated with the access control process, minimizing the impact of outdated or conflicting policies, improving the accuracy of automated solutions, and the like.

Consequently, further improvements to access control policies may address the aforementioned technical challenges and other challenges not mentioned.

### BRIEF SUMMARY

Various details of the present disclosure are hereinafter summarized to provide a basic understanding. This summary is not an exhaustive overview of the disclosure and is neither in tended to identify certain elements of the disclosure, nor to delineate the scope thereof. Rather, the primary purpose of this summary is to present some concepts of the disclosure in a simplified form prior to the more detailed description that is presented hereinafter.

According to an aspect of the present disclosure, a system for access control may include a graph database. The system for access control may include one or more processors coupled to the graph database, the graph database configured to store one or more policy nodes, each of the one or more policy nodes including a pointer to at least one external attribute-based access control (ABAC) document. The system for access control may include a policy information point (resolution manager) electronically coupled to the graph database and configured to traverse the graph database to identify one or more applicable policy nodes of the one or more policy nodes, the one or more applicable policy nodes based on a set of relationship edges (e.g., pathways along a graph within the graph database). The resolution manager may retrieve, via the pointer, the at least one external ABAC document from an external database, the at least one external ABAC document associated with the one or more applicable policy nodes. The system for access control may include a policy decision point (PDP) electronically coupled to the resolution manager and configured to query the resolution manager to retrieve the one or more applicable policy nodes and the at least one external ABAC document. The PDP may execute a dynamic subject enrichment pipeline, the dynamic subject enrichment pipeline aggregating the one or more applicable policy nodes.

In another aspect, a method for access control may include embedding, at a graph database, one or more policy nodes, each of the one or more policy nodes including a pointer to at least one external ABAC document. The method may include traversing, based on an access request, the graph database to identify one or more applicable policy nodes of the one or more policy nodes, the one or more applicable policy nodes based on a set of relationship edges. The method may include retrieving, via the pointer, the at least one external ABAC document from an external database, the at least one external ABAC document associated with the one or more applicable policy nodes. The method may include evaluating the one or more applicable policy nodes to resolve conflicts. The method may include, based on the evaluating, generating an access decision in response to the access request.

Other aspects of the present disclosure provide: one or more devices (e.g., apparatuses) operable, configured, or otherwise adapted to perform the aforementioned methods as well as those described elsewhere herein; a non-transitory, computer-readable media including computer-executable instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus including means for performing the aforementioned methods as well as those described elsewhere herein. By way of example, an apparatus may include a processing system, or processing systems cooperating over one or more message passing interfaces.

Any combinations of the various embodiments and implementations disclosed herein can be used in a further embodiment, consistent with the disclosure. These and other embodiments and features can be appreciated from the following description of certain embodiments presented herein in accordance with the disclosure and the accompanying drawings and claims.

### BRIEF DESCRIPTION OF THE DRAWINGS

Embodiments of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the embodiments disclosed herein may be practiced without these specific details, or with details that are not described herein in the interest of clarity. Thus, in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

FIG. 1 illustrates an example architecture for hybrid relationship-based access control (ReBAC) attribute-based access control (ABAC) (ReBAC-ABAC), in accordance with at least one embodiment of the present disclosure.

FIG. 2A illustrates an example components associated with the dynamic subject enrichment pipeline at a hybrid ReBAC-ABAC system, in accordance with at least one embodiment of the present disclosure.

FIG. 2B illustrates an example flow diagram depicting operations of a dynamic subject enrichment pipeline at a hybrid ReBAC-ABAC system, in accordance with at least one embodiment of the present disclosure.

FIG. 3 illustrates an example multi-level caching architecture implemented in conjunction with a hybrid ReBAC-ABAC system, in accordance with at least one embodiment of the present disclosure.

FIG. 4 illustrates an example flow diagram depicting operations of a policy language compiler at a hybrid ReBAC-ABAC system, in accordance with at least one embodiment of the present disclosure.

FIG. 5A illustrates an example flow diagram depicting a method for access control by a hybrid ReBAC-ABAC system, in accordance with at least one embodiment of the present disclosure.

FIG. 5B illustrates an example flow diagram depicting a method for hybrid ReBAC-ABAC, in accordance with at least one embodiment of the present disclosure.

FIG. 6 illustrates an example schematic diagram of a system for hybrid access control, in accordance with at least one embodiment of the present disclosure.

FIG. 7 illustrates an example schematic diagram of a computer system for hybrid access control, in accordance with at least one embodiment of the present disclosure.

FIG. 8 illustrates an example schematic diagram of a cloud-based computer system for hybrid access control, in accordance with at least one embodiment of the present disclosure.

FIG. 9 illustrates an example call-flow applicable to any of the systems and methods provided herein, in accordance with at least one embodiment of the present disclosure.

### DETAILED DESCRIPTION

Embodiments of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the embodiments disclosed herein may be practiced without these specific details, or with details that are not described herein in the interest of clarity. Thus, in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

Embodiments in accordance with the present disclosure generally relate to access control techniques, and more particularly to systems and methods for hybrid relationship-based access control (ReBAC) and attribute-based access control (ABAC) (ReBAC-ABAC).

Systems and methods provided herein provide a range of benefits that enhance access control mechanisms for authorization systems utilized by enterprise organizations. Distinguished by its graph-based architecture, the system is decoupled from relational database constraints and stores complete ABAC policy documents as referenced objects from graph nodes. The graph-based architecture provided herein implements a unified graph model where policy nodes exist as first-class entities with inheritance properties, supporting comprehensive policy documents with inheritance capabilities rather than limited expressions attached to relationships. Policy nodes embedded at a graph database may allow dynamic policy inheritance via graph connectivity, allowing for the automatic propagation of policies based on real-time relationships across any resource type, not just database entities. The full-featured policy nodes may contain pointers to external ABAC documents, inheritance properties, and versioning, allowing for comprehensive and flexible policy management within a graph-based architecture that, by way of the pointers, does not sacrifice system efficiency. The graph-based architecture may be predicated on a decentralized, graph-based model that supports vendor-neutrality and adapts to changing organizational structures.

Moreover, by integrating ABAC with graph-based ReBAC to create a hybrid access control scheme, systems and methods provided herein may create policies, themselves graph entities, which can be inherited, versioned, and managed independently. Additionally, the system utilized attribute-aware ReBAC, offering a production-ready architecture with concrete algorithms for policy inheritance, conflict resolution, and high-performance caching, ensuring practical and efficient implementation of advanced access control mechanisms. The system fully implements an integrated model that unifies ABAC and ReBAC within a single graph model, including complete policy node representation and inheritance, providing a comprehensive and cohesive access control solution. Overall, the disclosed system offers a robust, flexible, and efficient framework for managing access control policies in a dynamic and scalable manner.

### Authorization Models and Access Control Systems

An authorization model is a framework that defines the rules and mechanisms by which access to resources within a system is granted or denied. It establishes the criteria for determining who is allowed to perform specific actions on various resources (e.g., files, databases, containers, or services). Authorization models can vary widely in complexity and approach, ranging from simple role-based access control (RBAC) systems, where permissions are assigned based on user roles, to more sophisticated models like ABAC and ReBAC, which consider a multitude of attributes and conditions. The choice of an authorization model depends on the specific security requirements, organizational structure, and operational environment of the system. Effective authorization models ensure that only authorized users can access sensitive information and perform critical operations, thereby maintaining the security and integrity of the system.

ReBAC is an authorization model that leverages the relationships between entities within a system to determine access permissions. Unlike other access control models which rely on predefined roles or static policies, ReBAC uses graph-based relationships to dynamically evaluate access rights. This model allows for more granular and context-aware access decisions by considering the connections and interactions between users, resources, and other entities. For example, access can be granted based on the hierarchical relationship between a manager and their subordinates or the collaborative relationship between team members on a project. ReBAC is particularly effective in environments where relationships are complex and frequently changing, providing a flexible and scalable approach to access control.

ABAC is an authorization model that uses declarative policies to govern access to resources within a system. These policies are typically written in a high-level, human-readable language and specify the conditions under which access is granted or denied. ABAC allows for fine-grained control over access decisions by evaluating a wide range of attributes, such as user roles, resource types, environmental conditions, and contextual information. This model is highly flexible and can adapt to complex access requirements by defining detailed rules that consider various factors. ABAC is particularly useful in environments where access control needs to be precise and adaptable to changing conditions, providing a robust framework for managing permissions in a dynamic and scalable manner.

Without the benefit of the present disclosure, enterprise organizations face a challenge while utilizing authorization systems that implement either ReBAC or ABAC in isolation. ReBAC solutions leverage graph-based relationships but lack the fine-grained, declarative expressiveness of ABAC. Conversely, ABAC systems tend to be static and disconnected from dynamic relationship data. In some cases, to overcome authorization system challenges organizations might maintain an average of about 12-15 separate authorization systems, leading to inconsistent enforcement and security gaps. Administrators may spend about 30-40% of identity governance time managing role and relationship assignments, yet still miss about 15-20% of necessary access changes during organizational restructuring. Moreover, when relationships change within an enterprise organization, (e.g., project reassignments, departmental moves), about 68% of organizations report a lag of about 2-5 days before policy assignments correctly reflect new responsibilities. An administrative team may need to perform extensive manual configuration or tightly coupled integrations, which increases management overhead and restricts flexibility. This complexity leads to security gaps, administrative burdens, and reduced agility in responding to organizational changes.

### Embodiments Related to Hybrid Access Control

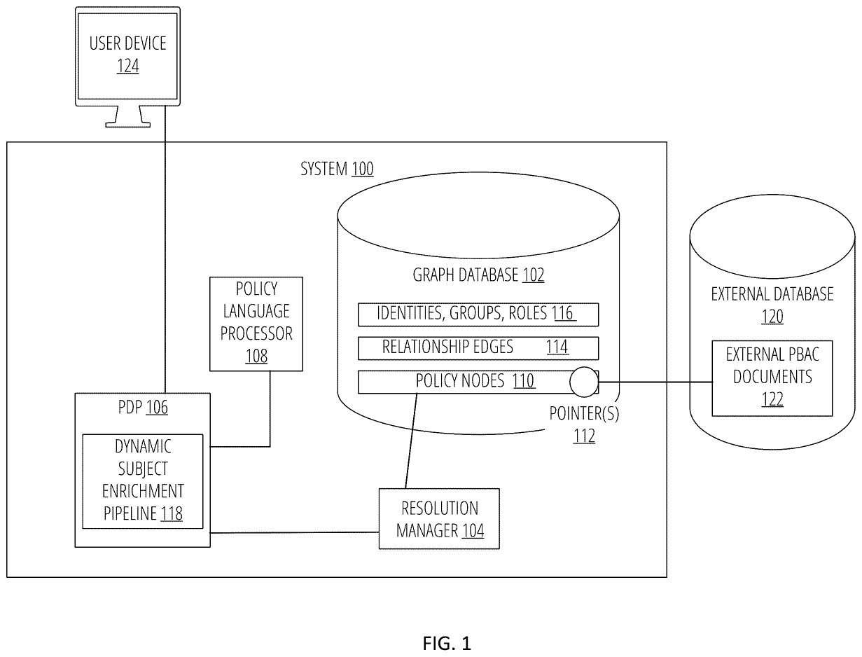

Embodiments described herein provide systems and methods for hybrid ReBAC-ABAC access control. For example, FIG. 1 illustrates an example hybrid ReBAC-ABAC architecture that may allow enterprise organizations to adapt more robustly to changing authorization conditions.

The hybrid ReBAC-ABAC architecture may include a system 100. System 100 includes a graph database 102, a resolution manager 104, a policy decision point (PDP) 106, and a policy language processor 108. Graph database 102, resolution manager 104, PDP 106, and policy language processor 108 may be communicatively and/or electronically coupled via one or more communication pathways and may be configured or otherwise arranged to obtain and output data from each other (e.g., via retrieval, querying, fetching, and the like). Graph database 102 includes policy nodes 110, relationship edges 114, and identities, groups, roles 116, which may be used to access one or more applicable policies via policy nodes 110 according to at least one of relationship edges 114 and identities, groups, roles 116. Policy nodes 110 include pointer(s) 112, which may be configured or otherwise arranged to “point to” (e.g., direct resolution manager 104 to, indicate) to at least one external ABAC document (e.g., external ABAC documents 122). PDP 106 includes dynamic subject enrichment pipeline 118.

In an alternative example, hybrid architecture may instead be a hybrid ReBAC-policy-based access control (PBAC) architecture for access control. The alternative ReBAC-PBAC architecture may include one or more processors coupled to the graph database, the graph database configured to store one or more policy nodes, each of the one or more policy nodes including a pointer to at least one external PBAC document. In such an alternative embodiment, ABAC supported features described herein may instead be PBAC supported features.

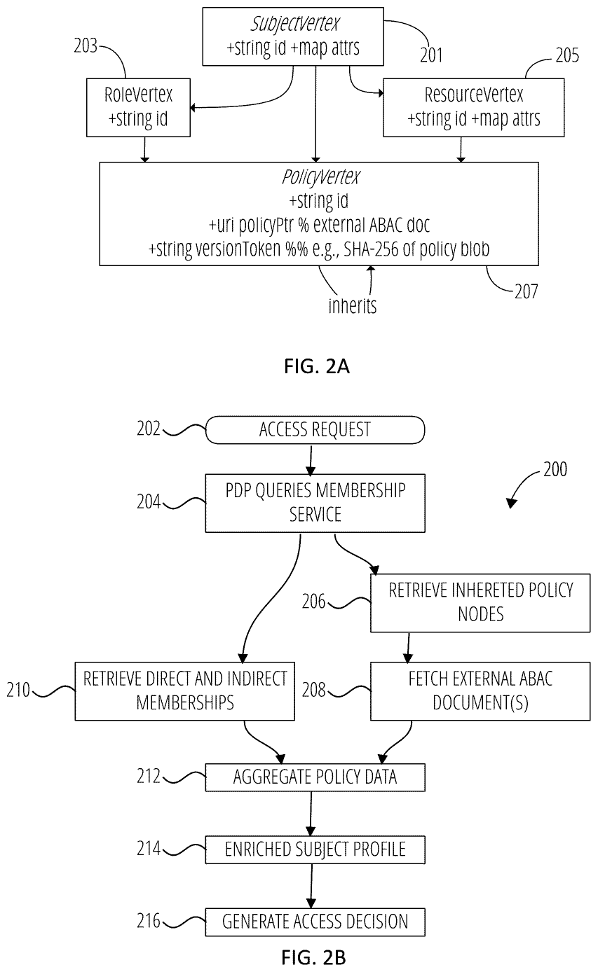

System 100 may be communicatively and/or electronically coupled to external database 120 and/or user device 124 via one or more communication pathways and may be configured or otherwise arranged to obtain data from and/or output data to external database 120 and/or user device 124. In one example, system 100 may be configured or otherwise arranged to obtain external ABAC documents 122 from external database 120 by way pointer(s) 112. In another example, system 100 may be configured to obtain an access request from user device 124 and, after implementing methods provided herein (see, e.g., FIGS. 2-5B), may output an access decision (e.g., “allow” or “deny”, along with other standard information) to user device 124 as a response to the access request. Communication at system 100 may be facilitated via a network.

In at least one embodiment, system 100 may be practically implemented as one or more cloud-based computer systems, one or more computer systems, one or more units, one or more databases, and/or one or more devices. In at least one embodiment, system 100 may have at least one memory and one or more processors having computer readable instructions stored thereon, which are capable of implementing hybrid access control schemes as part of implementations by system 100. The one or more processor(s) of system 100 may be central processing units (CPUs). The one or more processor(s) of system 100 may be graphics processing units (GPUs). Where there is more than one processor, each processor may operate independently from one another or as part of the same network of controllers and/or systems. Where multiple processors are part of the same network of controllers and/or systems, they may operate in sequence with one another, in parallel with one another, as physical components of a shared virtual machine, as components of a server-less network capable of processing decomposed flow data, as containerized applications that encapsulate software and its dependencies for execution across different computing environments, as microservices that independently deploy and scale discrete functionalities within an application, or as components of multi-tenant applications that serve multiple users or organizations from a single instance of the software while ensuring data isolation and security. Where there is more than one processor, each processor may undergo decomposition to perform some or all of a performance of a method, such as method 500 and/or method 512 described herein, in order to increase the efficiency of system 100.

Implementation of system 100 may include graph database 102 storing identity, role, and group nodes interconnected by relationship edges. Graph database 102 may also store and/or maintain policy nodes 110 embedded within the graph, each including one or more pointer(s) 112 to an external policy document (e.g., external ABAC documents 122) stored in a database (e.g., external database 120). Graph database 102 may also store relationship edges (e.g., hierarchy relationships) that enable policy inheritance along graph pathways. In some cases, graph database 102 may be a Neo4j graph database, thus facilitating the integration of dedicated policy nodes as first-class entities within the graph structure. A Neo4j graph database may serve as the foundational platform for resolution manager 104, enabling the storage and management of various entities such as identities, groups, roles, and their interrelationships. In at least one example, policy nodes 110 may be considered policy vertices.

Hybrid ReBAC-ABAC architecture of FIG. 1 may be enhanced by the inclusion of policy nodes 110, which are integrated as primary entities within the graph database 102. This integration allows for a more dynamic and flexible management of policies in relation to the stored entities. In some cases, policy nodes 110 may have inheritance properties controlling propagation direction, override behavior, and conflict resolution strategy.

Within the hybrid ReBAC-ABAC architecture of FIG. 1, each policy node within the graph may be structured to include several key components. In one example, a policy node may be uniquely identified by an “id” attribute, such as “finance_sensitive_data_policy.” The type of the node may be specified as “policy_node.” The policy node may include a pointer (e.g., pointer(s) 112) to an external ABAC policy document (e.g., external ABAC documents 122), which may be structured to include the storage system where the policy document is located, such as a Git-backed policy store, and a unique identifier for the policy document within the storage system. This integration allows for policies to be dynamically assigned and inherited throughout the graph. As a result, the system can generate a rich, context-aware authorization profile that adapts to the relationships and hierarchies defined within the graph (e.g., relationship edges 114 and/or identities, groups, roles 116). The policy node may define properties related to policy inheritance, including the propagation mode, which specifies how the policy is propagated through the graph, such as “downward”, the override mode, which may define how the policy interacts with parent policies, for example, “merge_with_parent”, and the conflict resolution method, which may specify how policy conflicts are resolved, such as “deny_overrides”. The policy node may also include metadata attributes, such as the timestamp indicating when the policy node was created, for example, “2025-01-15T08:43:21Z”, the version of the policy node, such as “2.1”, and the entity responsible for the policy node, for example, “security_team”.

Embodiments may implement a policy inheritance resolution process that tracks depth and specificity while aggregating policies along relationship edges. Policies may be grouped by an inheritance level, where higher specificity levels override lower ones. Within a given level, tie-breaking may prefer the most recently loaded policy. A resolver (e.g., resolution manager) may retain metadata for each effective policy, including the source policy node and the inheritance path that led to applicability. The process may propagate policies along graph relationships to form a final policy set that is applied to the request context. The aggregated resolution improves data locality and may reduce memory pressure by eliminating duplicate evaluations of lower-priority policies.

Implementation of system 100 may include resolution manager 104 traversing the graph database to discover direct and inherited policy assignments. In some cases, traversal by a resolution manager 104 may be in response to an access request (e.g., from a user device 124). resolution manager 104 may also retrieve referenced policy documents from the external document store, and maintain a synchronized index of policy-to-graph relationships. In at least one example, resolution manager 104 may include a retriever.

In at least one embodiment, system 100 may be configured or otherwise arranged for role and policy aggregation, where PDP 106 queries the membership service to retrieve both directly assigned roles and inherited policy nodes, thereby dynamically enriching the subject's authorization context. Implementation of system 100 may include PDP 106 receiving access requests specifying a subject, resource, and action. PDP 106 may also query resolution manager 104 to retrieve all applicable policies via graph traversal, PDP 106 may also execute a dynamic subject enrichment pipeline that aggregates both direct and inherited policies. PDP 106 may also evaluate all applicable policies according to a hierarchical deny-override rule. PDP 106 may also evaluate the combined policies against the subject, resource, action, and context, generating an access decision based on the evaluation, applying policy inheritance rules to automatically propagate policies along relationship paths in the graph. PDP 106 may also issue standardized authorization decisions with attached obligations. PDP 106 may also resolve policy conflicts using a configurable conflict resolution strategy, where deny decisions override allow decisions by default.

Systems and methods provided herein address fragmented policy storage and high-latency lookups by embedding policy nodes in a graph database and associating each node with a pointer to an external policy document. A resolution manager may traverse relationship edges to identify applicable policy nodes for a given request, and a policy decision point may execute a dynamic subject enrichment pipeline to aggregate those nodes into an evaluable context. Treating policies as first-class graph entities may improve data locality at runtime, reduce memory pressure by avoiding wide scans across disparate stores, and limit interconnect activity by retrieving only referenced documents via the pointer. Applying hierarchical rules, such as deny-override during aggregation, may curtail redundant evaluation paths, which consolidates workflow steps and may shorten execution time on available processors.

In some cases, embodiments may include application-scoped policy resolution to support multiple applications served by a single PDP instance (e.g., PDP 106) while maintaining isolation. System 100 may maintain a registry that maps application identifiers to policy directory paths, and may extract application context from authorization requests to determine the relevant registry entry. Policies may then be loaded only from directories associated with the extracted application identifier. Cache keys for policy data may include an application identifier, which may prevent cross-application cache reuse and reduce cache pollution. This approach consolidates workflow steps and may shorten execution time in multi-tenant environments by improving data locality and reducing unnecessary cache lookups.

In some cases, embodiments may include obligation handling integrated with the PDP. Policies may declare obligations in YAML or JSON that are executed upon permit or deny decisions. The PDP may maintain a registry that maps obligation identifiers to handler functions, and may automatically execute obligations as part of decision finalization. Execution outcomes may be recorded in decision metadata. Handler functions may receive decision context parameters, which may allow consistent logging, additional checks, or follow-up actions. This integration consolidates workflow steps and may shorten execution time by avoiding external orchestration for common obligation behaviors.

In some cases, PDP 106 may implement a specialized graph traversal algorithm. In such a case, a policy administration point may provide interfaces for policy authoring and management, validating policies for syntactic and semantic correctness, and managing policy versioning and deployment. The specialized graph traversal algorithm may be configured or otherwise arranged to efficiently discover and aggregate all applicable policies. An example of the algorithm may operate as follows: Collections for direct policies and inherited policies are initialized. The subject's direct role assignments and group memberships are retrieved using a graph query. For each role, directly attached policies are identified and added to the direct policies collection. Inherited policies are discovered through the group hierarchy, which can span multiple levels. The query matches the subject to groups and their associated policy nodes, ordering the results by the depth of the shortest path.

Actual policy documents are retrieved from a Git-backed policy store. For each policy node in the combined direct and inherited policies collections, the system fetches the policy document either from cache or a Git-backed policy store. If the document is available, it is added to the policy documents collection along with metadata such as the source policy node and inheritance level. The system applies inheritance rules and conflict resolution mechanisms to the collected policy documents, resulting in a set of resolved policies. The final set of policies applicable to the access request is returned. After synthesizing the enriched context, the PDP issues an access decision in a standardized format.

The standardized decision output of PDP 106 may conform to OpenID AuthZen 1.1, and may be constructed in conjunction with policy language processor 108. Policy language processor 108 may include a large-language model (LLM)-assisted policy authoring component to help translate natural language requirements into formal policy syntax. This may allow the policy language processor to verify policy correctness, identify potential conflicts, and generate human-readable explanations of complex policies.

Implementation of system 100 may include policy language processor 108 parsing human-readable policy syntax (e.g., including “allowIf/denyIf” constructs), converting them to executable condition trees that can be efficiently evaluated during authorization requests. Policy language processor 108 may also process policies written in a human-readable language supporting allowIf/denyIf constructs, compound conditions, and path pattern matching. System 100 may support policy language processor 108 via syntactic sugar constructs, path pattern matching with wildcards and parameter extraction, and obligations specifying required actions upon permit or deny decisions. Path pattern matching may support single-segment and multi-segment wildcards, and parameter extraction using named placeholders.

In at least one example, embodiments may implement a policy inheritance resolution process that tracks depth and specificity while aggregating policies along relationship edges. Policies may be grouped by an inheritance level, where higher specificity levels override lower ones. Within a given level, tie-breaking may prefer the most recently loaded policy. A resolver (e.g., resolution manager) may retain metadata for each effective policy, including the source policy node and the inheritance path that led to applicability. The process may propagate policies along graph relationships to form a final policy set that is applied to the request context. The aggregated resolution improves data locality and may reduce memory pressure by eliminating duplicate evaluations of lower-priority policies.

In at least one example, embodiments may define discrete inheritance levels that encode the specificity of policy propagation across relationship edges. In one example, levels may include “GLOBAL,” “DOMAIN_SHARED,” “CROSS_ENVIRONMENT,” “DOMAIN_ENVIRONMENT,” and “APPLICATION.” A resolver (e.g., resolution manager) may group discovered policies by inheritance level, prioritize more specific levels over general levels, and resolve ties within a level based on load order. The resolver may retain metadata for each effective policy, including the assigned inheritance level and the relationship path used for propagation. This grouping and precedence may improve data locality and may reduce memory pressure by limiting evaluation of lower priority policies.

PDP 106 includes dynamic subject enrichment pipeline 118. By way of an additional example, FIG. 2A illustrates components associated with the dynamic subject enrichment pipeline 118 of FIG. 1. Specifically, FIG. 2A illustrates a logical model which may be implemented at the ReBAC-ABAC system. The logical model includes a SubjectVertex 201, a Role Vertex 203, a Resource Vertex 205, and a Policy Vertex 207. Each of these components may inherit attributes and relationships that define their roles within the system. Policy Vertex 207 may be characterized by attributes such as a string identifier (id), a pointer to an external ABAC document (policyPtr), and a version token (versionToken), which could be, for example, a SHA-256 hash of the policy blob. This vertex may be responsible for defining the policies that govern access control within the system. Subject Vertex 201 may include a string identifier (id) and a map of attributes (attrs). This vertex may represent the subjects, or users, within the system, and their associated attributes, which may be used to evaluate access control policies. Similarly, Resource Vertex 205 may also include a string identifier (id) and a map of attributes (attrs). This vertex may represent the resources within the system that are subject to access control policies. Lastly, Role Vertex 203 may be defined by a string identifier (id). This vertex may represent the roles that can be assigned to subjects, which may influence the evaluation of access control policies. The relationships between SubjectVertex 201, Role Vertex 203, Resource Vertex 205, and Policy Vertex 207 may be many-to-many, allowing for a flexible and scalable model that can accommodate complex access control requirements. Each component may inherit attributes and relationships that enable the system to evaluate access control policies based on a wide range of factors, ensuring precise and adaptable access control. In one example, policy files at Policy Vertex 207 are version-controlled YAML Ain't Markup Language (YAML, recursive) documents stored in a Git repository; the pointer encodes the repository, path, and commit hash, guaranteeing reproducible evaluation. In another example, policy files at Policy Vertex 207 are version-controlled JavaScript Object Notation (JSON) documents expressed as JSON intermediate representation (JSON IR) stored in a Git repository or a relational or document database, and the pointer encodes at least one of a repository path and commit identifier or a database key, which may enable reproducible retrieval and type-preserving evaluation.

By way of an additional example, FIG. 2B illustrates operations performed in association with dynamic subject enrichment pipeline 118 of FIG. 1. Operations of FIG. 2B begin with receiving an access request at block 202 and end with generating an access decision at block 216. At block 202, an access request may be received at a system (e.g.,, system 100). At block 204, PDP 106 gathers direct roles and/or membership service. At block 206, PDP 106 retrieves inherited policy nodes (e.g., by way of resolution manager 104). At block 208, PDP 106 fetches external ABAC documents (e.g., by way of resolution manager 104). At block 210, PDP 106 retrieves detailed policies and/or direct and indirect memberships. In at least one example, the ABAC document is fetched via git command. In at least one example, the ABAC document is fetched via shallow clone and/or instructions (e.g., YAML or JSON). At block 212, dynamic subject enrichment pipeline 118 aggregates all data. In some cases, aggregation includes aggregating policies from multiple inheritance paths, resolving conflicts based on inheritance level and specificity, and applying deny-override rules. Thus, aggregation at block 212 generates an enriched subject profile at block 214. At block 216, PDP 106 generates an access decision based on the enriched subject profile.

In at least one embodiment, system 100 may communicate with external database 120 (e.g., via a network). External database 120 may store external policy documents, such as external ABAC documents 122. External database 120 may be a document oriented database configured or otherwise arranged to store version information, conditions expressed in a human-readable format, and obligations to be fulfilled upon permit or deny decisions. External database may store external ABAC document 122, which may be a JavaScript object notation (JSON) formatted document. External database 120 may include one or more of relational databases (RDBMS) which use structured query language (SQL) for data management, NoSQL databases (e.g., document stores, key-value stores, column-family stores, graph databases), in-memory databases, NewSQL databases, time-series databases, object-oriented databases, hierarchical databases, network databases, distributed databases, cloud databases, multimodel databases, embedded databases, and the like. External database 120 may be treated as a data warehouse, data lake, data well, or another storage system. External database 120 may be optimized for hybrid access control, allowing the hybrid ReBAC-ABAC architecture to perform methods described herein.

In at least one embodiment, user device 124 of the hybrid ReBAC-ABAC access control architecture of FIG. 1 includes a browser, which may access system 100 and interact with resolution manager 104 via network 120. In at least one embodiment, user device 124 can be any electronic computing device. User device 124 may be a computing device that has a display. A user can enter control inputs through a user interface, such as a keyboard, microphone, or touchscreen. For example, user device 124 can include, but is not limited to, a mobile computing device (such as a smartphone or tablet computer), wearable computing device (such as a smart watch or headset), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display, or other input/output device. A communication interface and transceiver can be included to perform data communication, wired or wireless, over network 120. In at least one embodiment, user device 124 may be a remote computing device that includes a tool having a user interface configured to allow a user to submit access requests and receive authorization decisions generated by system 100.

In at least one embodiment, system 100 may be implemented in a dynamic cloud environment. Dynamic cloud environments are modern computing landscapes that leverage advanced technologies such as containers, microservices, serverless architectures, and multi-tenant applications to deliver scalable, flexible, and efficient services. These environments are supported by robust hardware infrastructure, including high-performance servers, storage systems, and networking equipment, which enable the dynamic allocation of resources and adjustment of workloads in response to real-time demands. Serverless architecture, in particular, abstracts the underlying hardware and infrastructure management, allowing developers to focus solely on writing code while cloud providers handle provisioning, scaling, and server management. Containers may facilitate consistent operation across different environments, and microservices may allow for independent development and scaling of application components. Multi-tenant architectures may enable multiple users to share the same hardware while maintaining data isolation and security. In dynamic cloud environments, access control requires both rich contextual attributes (time of day, risk score, location) and multi-hop relationship checks. The hybrid ReBAC-ABAC architecture may unify each of these paradigms within a single architecture.

In at least one embodiment, a network may facilitate communication across the hybrid access control architecture of FIG. 1. The network may be practically implemented as one or more networks. Network may be a wired network, a wireless network, or a combination of both. In at least one embodiment, a wireless network may include a wireless local area network (WLANs) (e.g., a wireless fidelity (Wi-Fi) network), a wireless personal area networks (WPANs) (e.g., a Bluetooth network, a Zigbee network), a wireless metropolitan area network (WMANs) (e.g., a worldwide interoperability for microwave access (WiMAX) network), a wireless wide area network (WWANs) (e.g., a fourth generation long-term evolution (4G LTE) network, a fifth generation new radio (5G NR) network, satellite networks, mesh networks, ad hoc networks, near field communication (NFC) networks, infrared (IR) communication networks, ultra-wideband (UWB) networks, long range wide area networks (LoRaWAN) (e.g., a network optimized for Internet-of-Things (IOT) applicability), and the like.

### Example Multi-level Caching Architecture

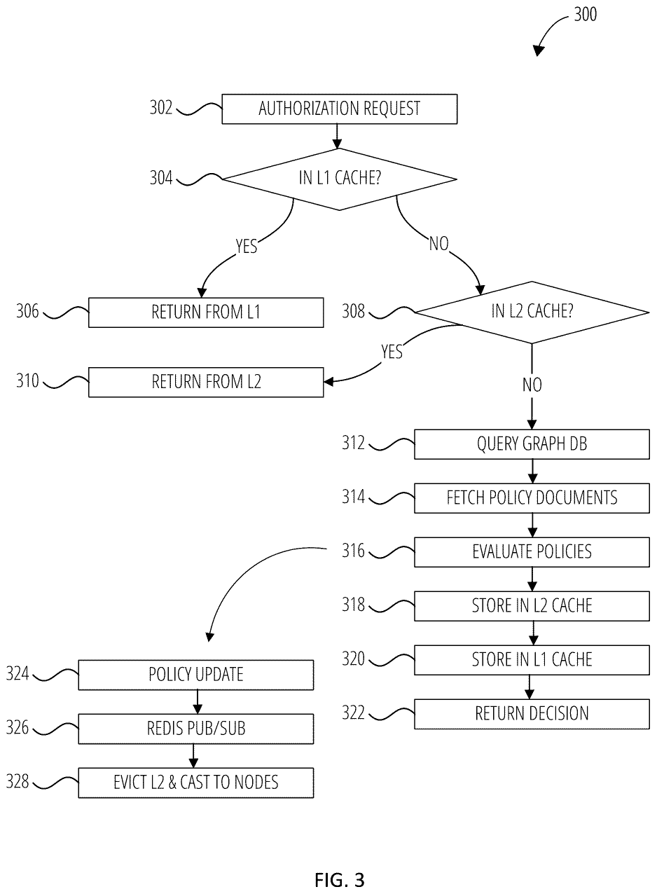

In at least one embodiment, system 100 of FIG. 1 may include or operate in conjunction with a multi-level caching architecture with a local in-memory least recently used (LRU) cache, a distributed Redis cache, and automatic invalidation mechanisms triggered by Git post-receive webhooks when a policy file is updated or a new commit is pushed. By way of example, FIG. 3 illustrates operations performed in association with the multi-level caching architecture. When an authorization request is received at block 202, the system first checks if the request is present in the layer 1 (L1) cache at block 304. If the request is found in the L1 cache, the system returns the cached decision at block 306. If the request is not found in the L1 cache, the system then checks the layer 2 (L2) cache at block 308. If the request is found in the L2 cache, the system returns the cached decision from the L2 cache at block 310. If the request is not found in either cache, the system proceeds to query the graph database to retrieve the necessary data at block 312. The system fetches the relevant policy documents at block 314 and evaluates the policies to make an authorization decision at 316. Optionally, following step 316 or another suitable step, if there is a policy update at block 324, the system triggers a Redis pub/sub mechanism at block 326, which evicts the L2 cache and broadcasts the update to all nodes at block 328. Once a policy decision is broadcast at block 324, it may be stored in both the L2 cache at block 318 and the L1 cache at block 320 for future requests. Finally, the system returns the authorization decision at 322.

In at least one example, embodiments may augment the multi-level caching architecture of FIG. 3 with a stale-while-revalidate (SWR) pattern and entity tag (ETag) based invalidation. SWR may return a stale cached policy immediately, while a background task refreshes the entry without blocking the request path. In at least one example, a SWR may be considered a caching pattern where a stale value is returned immediately while a background refresh updates the cache (e.g., any of L1 cache, L2 cache). In at least one example, an ETag may be considered a hash-based token computed from resource metadata, used to detect changes and validate cache entries.

An ETag may be computed as a SHA-256 hash over directory metadata, such as modification times and file sizes, and may be checked before recalculation to avoid redundant work. The system may maintain in-flight load deduplication so that concurrent requests for the same cache key share a single loading future. In some cases, embodiments may support pre-compiled, continuous integration bundles packaged as JSON, which may be validated against ETag and used as a fast path, with a fallback to file-based loading. Background refresh may be bounded by a semaphore to provide backpressure. Request-level caching with TTL and ETag validation may be applied to frequently requested policies. These mechanisms curb interconnect load and I/O traffic and may reduce energy use by avoiding repeated reads. In some cases, embodiments may incorporate performance optimizations that improve policy loading throughput. The system may read multiple policy files in parallel up to a configurable concurrency limit, and may offload blocking file I/O and directory scanning to a thread pool to avoid event loop stalls. Instrumentation may expose cache hit and miss counters, policy load duration histograms, and gauges for in-flight loads. Request-level caching may apply TTL and ETag validation to reduce repeated work. These optimizations reduce read-write activity and may lower power draw while maintaining consistent request latency under load.

In at least one example, embodiments may include parser behaviors that improve robustness during policy compilation. The parser may temporarily mask quoted segments to avoid false matches when scanning for operators, may apply quote-aware regular expressions for “IS NULL” and “IS NOT NULL” conversions, and may restore masked segments before constructing the evaluable condition tree. Inline comments may be supported to improve maintainability without affecting execution. These measures may streamline data handling and lower system overhead by preventing re-parsing due to malformed matches. In some cases, embodiments may include a whitelist of helper functions callable within policy expressions. The whitelist may be enforced by the policy language processor to prevent arbitrary function execution, and may include functions for common checks such as “capabilities_prefix_any,” “path_match_any,” “string_contains_any,” and “list_intersects.” The whitelist may be configurable to allow controlled extension. This design consolidates workflow steps and may shorten execution time by restricting evaluation to vetted operations.

In some cases, the L1 cache (e.g., local memory) may operate on a per-node basis using an in-memory LRU cache. Its purpose is to provide ultra-fast responses for repeated authorization requests, with a time-to-live (TTL) that is configurable, typically ranging from about 5 seconds or more to about 30 seconds or less, though other values are contemplated. Invalidation of this cache may occur automatically upon policy update events. The L2 Cache (e.g., distributed Redis) functions as a cluster-wide distributed cache. Its purpose is to ensure consistent responses across service nodes, with a TTL that is configurable, typically ranging from about 1 minute or more to about 5 minutes or less, though other values are contemplated. Invalidation in this cache is managed through a publish/subscribe model on policy changes. The multi-level caching architecture may also include a cache warm-up mechanism, which involves predictive pre-caching of frequently accessed policies. This automatic warm-up occurs following a service restart and includes periodic refreshes based on access patterns. The invalidation strategy for the multi-level caching architecture may be event-driven, triggering invalidation when policies change. Further, the invalidation strategy may employ selective invalidation based on policy dependencies and version-based validation before serving cached decisions.

In at least one example, embodiments of the multi-level caching architecture of FIG. 3 may maintain explicit state to implement SWR behavior and deduplicate concurrent loads during policy retrieval. Systems described herein may track in flight loads in a map keyed by a cache key, each entry referencing a future or promise representing the active load. A background refresh registry may record tasks per cache key for asynchronous revalidation, and a staleness tracking map may store first seen timestamps and thresholds used to decide when stale values are returned and refreshed. In at least one case, request cache keys may include an application identifier to preserve isolation in multi-application deployments, consistent with application scoped resolution. These structures curb interconnect load and I/O traffic and may reduce energy use by avoiding redundant reads and duplicate computations along the request path.

The multi-level caching architecture addresses of FIG. 3 repeated loads and cross-node inconsistencies by combining a local in-memory LRU cache with a distributed cache and event-driven invalidation. In some cases, a stale-while-revalidate pattern may return a cached decision immediately while a background refresh updates the entry, and request-level caching may include TTL and ETag validation for frequently requested policies. These behaviors may curb interconnect load and I/O traffic by serving hot decisions from local memory, reduce read-write activity to external stores through coordinated invalidation, and stabilize resource usage across service nodes. As a non-limiting example, the two-tier structure may improve data locality on individual processors while maintaining consistency across the cluster, which may lower power draw under bursty authorization traffic.

### Example Policy Language Processor

Policy language processor 108 may be implemented in conjunction with a policy definition language (PDL) configured or otherwise arranged to operate alongside systems and methods provided herein. The PDL that incorporates “syntactic sugar” to enhance the readability of policies while maintaining robust expression capabilities. The PDL is configured or otherwise arranged to simplify the creation and management of policies without sacrificing the complexity and precision required for effective policy enforcement. The PDL features an intuitive syntax that allows for more straightforward policy definitions. For example, a traditional syntax might specify an effect as “ALLOW” when the condition “subject.department==‘Finance’” is met. The enhanced syntax, or “sugar syntax,” simplifies this to “allowIf: ‘subject.department==‘Finance’”, making the policy easier to read and understand.

The PDL also includes advanced logical constructs to facilitate complex policy definitions. It supports constructs such as “all,” “any,” and “none” for combining multiple conditions, as well as “exceptIf” and “unless” for handling exceptions. Additionally, the PDL provides “if/then/else” constructs for conditional branching, enabling the creation of nuanced and context-sensitive policies. Another key feature of the PDL is its support for path pattern matching. This includes hierarchical resource addressing with wildcards, allowing for flexible and comprehensive resource specification. The PDL also supports pattern-based resource matching with variables, enabling dynamic and context-aware policy enforcement. Furthermore, it allows for parameter extraction from paths, providing additional granularity and control over policy application.

Systems and methods provided herein may be implemented in conjunction with an enhanced document access policy. In one example, an example enhanced document access policy may be given the identifier “document-access-policy” and version “2.0.” This example policy may be designed to control access to documents based on their classification. The example policy may apply to subjects of type “group” with the identifier “finance-team.” It may include rules that specify the conditions under which access is granted. For the resource type “document” and the action “view,” access may be allowed if the subject's department is “Finance.” Additionally, the example policy may include path conditions that restrict access to documents located at the path “/docs/financial/.pdf.” Upon granting access (on permit), the example policy may impose obligations to log the access event. The obligation may be identified as “audit_log” and includes attributes specifying the action “log_access.” The policy also defines path attributes with the name “document_path” and type “path.” The allowed document paths may be specified by patterns, including “/docs/financial/.pdf” and “/reports/**/*xlsx.” These patterns may describe the document paths that are permitted under the example policy. As described, the example policy ensures that only members of the finance team can view documents located in specified paths, and it mandates logging of access events for auditing purposes.

Policy language processor 108 converts human-readable policy syntax into executable condition trees that the system may evaluate directly during authorization requests. Structured compilation, including path pattern matching and normalized condition evaluation, may streamline data handling and lower system overhead by avoiding ad hoc parsing at request time. Executing compiled trees within the dynamic subject enrichment pipeline may reduce transient allocations and working set size, which can improve cache efficiency across cores. In combination with graph-anchored discovery and the caching architecture, the compiled evaluation path may reduce I/O dependencies and CPU cycles per decision, offering predictable performance characteristics that align with hardware constraints in multi-tenant and cloud deployments.

### Example Policy Representation

Embodiments may support external policy documents in both YAML and JSON formats, with JSON utilizing an IR to provide a structured, executable form for policy evaluation. IR refers to a machine-readable format that encodes structured bindings, static values, and expressions while preserving native types throughout evaluation. Policy pointers at graph nodes (e.g., FIG. 2A, Policy Vertex 207) may reference YAML files stored in a Git repository or JSON IR artifacts stored in a file store or a relational database, and resolution manager 104 may retrieve either format using pointer metadata and provide parsed content to PDP 106 for evaluation (see FIG. 1). Where type preservation and clarity during policy authoring and execution are prioritized, JSON IR policy documents with structured bindings, static values, and expressions may ensure arrays and objects remain native during retrieval and evaluation. YAML policy documents are deemphasized. JSON may further offer advantages that complement IR usage, including unambiguous native arrays and objects, portability across implementation languages due to widespread parser support, schema-based validation that confirms structure prior to execution, and predictable parsing behavior that improves pre-execution checks and debugging in multi-language environments.

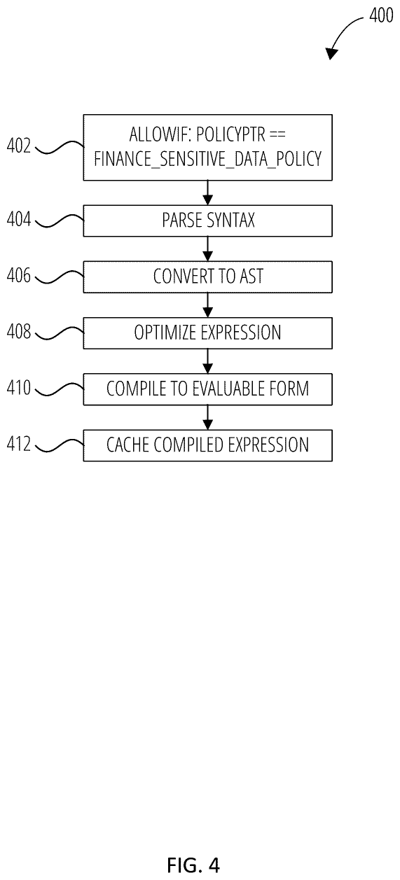

Systems and methods provided herein may employ JSON intermediate representation (JSON IR) semantics that encode runtime references, literals, and computed operations without templates. A binding may specify a path to a runtime attribute with an optional default value, a static value may remain a native type such as an array or an object, and an expression may specify an operator and arguments that include bindings or literals. Policy language processor 108 may parse these JSON IR constructs and convert them into executable condition trees (see FIG. 4), allowing direct evaluation during authorization requests with consistent type preservation across subject, resource, and context attributes. Relative to template-based configurations in YAML, JSON IR may avoid stringification of arrays and objects and subsequent reparsing, which may streamline data handling and lower system overhead. Structured evaluation may use operator descriptors such as equals, add, split, length, contains, and array_append, preserving operand types and avoiding string-based execution. These measures improve data locality and may reduce memory pressure within the dynamic subject enrichment pipeline (see FIG. 2B).

In at least one example, embodiments described herein may store JSON IR policies in a Git backed repository, a document oriented database, or a relational database. A policy node pointer may encode a repository path and commit identifier for file based retrieval, or may include a database key that identifies a JSON IR record. The retrieval flow may integrate with the multi-level caching architecture (see, e.g., FIG. 3), where request level caching may include TTL and ETag validation for IR backed policies, and SWR behavior may return a cached result while a background task refreshes the entry. Where multiple applications are served by a single PDP instance, application scoped cache keys may preserve isolation and prevent cross application cache reuse. In some embodiments, explicit state may support SWR and deduplication, including a map of inflight loads keyed by cache key, a background refresh registry keyed by cache key, and a staleness tracking map that records first seen timestamps and thresholds. These mechanisms curb interconnect load and I/O traffic and may reduce energy use by avoiding repeated reads, conversions, and duplicate computations along the request path.

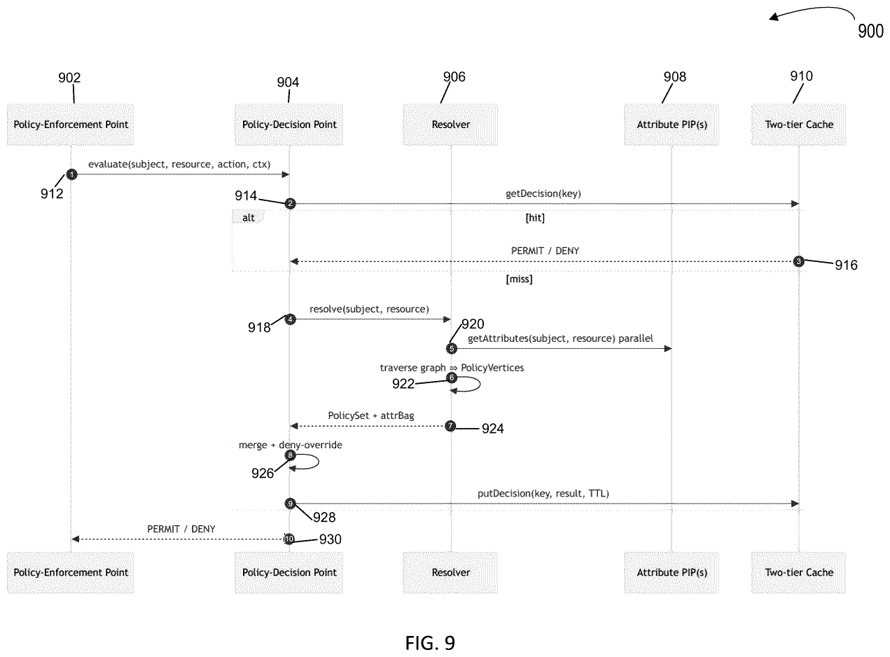

Certain non-limiting use cases may illustrate JSON IR behavior in production contexts. In one example, service configuration parameters may combine bindings and static values to preserve native types end to end, such as binding a subject identifier to a runtime attribute, providing scopes as a literal array, binding capability lists from context, and binding metadata with a default empty object when absent; the policy language processor evaluates these constructs without templates, consolidating workflow steps in FIG. 2B and reducing intermediate conversions. In another example, safe conditional transitions may compare a resolved attribute to a literal using an equals operator before proceeding, avoiding string based evaluation and preserving types for compared operands; this may shorten execution time prior to decision issuance in FIG. 9, described below. Attribute normalization may convert and transform values as part of evaluation, such as converting a numeric threshold to integer before comparison or splitting an email string to extract a segment for downstream checks, which may streamline data handling and lower system overhead. Membership checks and array operations may use native list semantics to verify the presence of a capability or extend a set of scopes, reducing string re-parsing when constructing authorization context for PDP 106 (see, e.g., FIG. 1). Robust fallback behaviors may use defaults and “if else” selections when a referenced attribute is missing, reducing read-write activity and preventing error driven retries. Direct mapping may assign resolved values from response paths to target attributes for subsequent evaluation steps, consolidating workflow stages and improving throughput within the dynamic subject enrichment pipeline (see, e.g., FIG. 2B).

### Example Implementations

In one non-limiting example, the disclosed system includes policy nodes as first-class entities within the graph database, exemplified by the following structure. Each policy node may be uniquely identified by an “id” attribute, such as “finance_document_access_policy,” and may be designated as a “policy_node” type. The policy node may contain a “policy_document_pointer” that references an external policy document stored in a Git-backed policy store, such as a private GitLab or GitHub repository exposed over HTTPS. This pointer may include attributes such as the scheme “git,” the repository name “security-policies,” the path “finance/sensitive_data. yaml,” and the commit identifier “fd8c73e5-9e1a-4d85-9453-dd7734821b24.” The policy node may also include “inheritance_properties” that define how policies are propagated and managed within the graph. These properties may specify at least one of “propagation_mode” of “downward,” an “override_mode” of “merge_with_parent,” a “conflict resolution” strategy of “deny_overrides,” and an “inheritance_depth” set to “unlimited.” This structure may allow for flexible and hierarchical policy management. Additionally, the policy node may contain “metadata” attributes that provide contextual information about the policy. These attributes may include the creation timestamp “created_at” set to “2025-01-15T08:43:21Z,” the creator's identifier “created_by” as “admin@example.com,” the last modification timestamp “last_modified” set to “2025-02-01T14:22:17Z,” a “description” of “Controls access to financial documents,” and relevant “tags” such as “finance,” “compliance,” and “sensitive-data.” The policy node may also include a “caching_directive” that specifies caching behavior. This directive may set the “priority” to “high,” a TTL of about 300 seconds, and a “preload” attribute set to true, which may allow the policy to be available for access control decisions. This example illustrates the comprehensive structure and capabilities of policy nodes within the disclosed system, enabling robust and flexible policy management in a graph-based architecture.

In one non-limiting example, the system 100 may employ a specialized algorithm for discovering and evaluating policies. For example, the specialized algorithm may be named “ResolveApplicablePolicies.” ResolveApplicablePolicies may initialize tracking variables for direct policies, inherited policies, and effective permissions. ResolveApplicablePolicies may first find all policies directly assigned to the subject by executing a graph query that matches the subject to policy nodes and may return the policies with an inheritance level of zero and an assignment type of “direct.” Next, ResolveApplicablePolicies may identify policies inherited through group memberships by executing a graph query that matches the subject to groups and their associated policy nodes, ordering the results by the shortest path length to determine the inheritance level. These group-inherited policies may be added to the inherited policies list. ResolveApplicablePolicies may then find policies inherited through role assignments by executing a graph query that matches the subject to roles and their associated policy nodes, assigning an inheritance level of one and an assignment type of “role.” These role-inherited policies may also be added to the inherited policies list. Additionally, ResolveApplicablePolicies identifies resource-specific policies by executing a graph query that matches the resource to policy nodes, returning the policies with an inheritance level of zero and an assignment type of “resource.” All discovered policies, including direct, inherited, and resource-specific policies, may be combined into a single list. ResolveApplicablePolicies may retrieve the actual policy documents from a Git-backed policy store for each policy node in the combined list, may check if each policy applies to the given resource and action, and may evaluate the policy conditions against the subject, resource, and context. The results, including the effect, inheritance level, assignment type, and any obligations, may be tracked in the effective permissions dictionary. Finally, ResolveApplicablePolicies may resolve any conflicts among the effective permissions to determine the final decision, which is then returned.

In one non-limiting example, a compiler may be included at policy language processor 108. The compiler may transform the human-readable policy language into an optimized execution format. For instance, an original policy condition may specify that access is allowed if all of the following conditions are met: the subject's role is “Admin,” the subject is active, and the resource's classification is less than or equal to the subject's clearance. The compiler converts this human-readable condition into a compiled condition tree. In response to the met conditions, the compiler may compile condition tree that uses an “AND” operator to combine the conditions, with each condition represented as a structured object. In one case, the first condition may check if the subject's role equals “Admin” using an “EQUALS” operator, comparing the “subject.role” path to the literal value “Admin.” The second condition may check if the subject is active using an “EQUALS” operator, comparing the “subject.active” path to the literal value true. The third condition may check if the resource's classification is less than or equal to the subject's clearance using a “LESS_EQUAL” operator, comparing the “resource. classification” path to the “subject. clearance” path. This transformation ensures that the policy conditions are efficiently executable by the system.

Systems and methods provided herein may extend policy language processor 108 to support additional operators (e. g, domain specific language operators (DSL)) and parsing behaviors that simplify policy authoring while preserving evaluability. For example, in some embodiments, policy language processor 108 may parse and evaluate a “CONTAINS” operator and a “NOT CONTAINS” operator for array and string containment checks, and “IS NULL” and “IS NOT NULL” operators for natural null handling. Policy language processor 108 may further accept an “IMPLIES” operator for logical implication, which may be rewritten to an equivalent form before evaluation. In one example, policy language processor 108 masks quoted substrings, detects an “IMPLIES” pattern using case-insensitive word boundaries, splits the expression into left and right components, rewrites the expression to “NOT” (left) “OR” (right), and then restores the masked substrings. Policy language processor 108 may maintain a helper function whitelist that restricts callable functions to a predefined set for safety, such as “capabilities_prefix_any, path_match_any,” “string_contains_any,” and “list_intersects.” Policy language processor 108 may also support inline comments in expressions and recognize null and none as null literals. These features may streamline data handling and lower system overhead during compilation and evaluation.

FIG. 4 illustrates an example procedure for the compiling process as performed by the compiler. Compiling begins at block 402 with introduction of the policy condition “policyPtr==finance_sensitive_data_policy”. In response to the condition the procedure parses the syntax of the policy statement at block 404. The parsed syntax is then converted into an abstract syntax tree (AST) at block 406 to represent the hierarchical structure of the policy condition. The AST may be optimized at block 408 to simplify and enhance the efficiency of the expression. The optimized expression is then compiled at block 410 into an evaluable form that the system can execute. Finally, the compiled expression is cached at block 412 to improve performance for future evaluations of the same policy condition.

The ReBAC-ABAC hybrid access control system represents a significant advancement in authorization technology by merging ReBAC and ABAC, enabling dynamic, graph-based policy inheritance combined with external ABAC policy retrieval in a unified architecture not found in any existing system. It automates policy propagation, reducing manual configuration through graph-based inheritance, providing a richer authorization context, and eliminating administrative overhead. The system introduces policy language innovations, offering a human-friendly yet powerful policy definition language with syntactic sugar, advanced logical constructs, and path pattern matching. It delivers standardized decisions, ensuring interoperability with industry protocols.

Systems and methods provided herein offer substantial performance benefits and metrics that enhance evaluation speed, administrative efficiency, and scalability of access control. The ReBAC-ABAC hybrid architecture provides significant improvements over traditional architectures, including about 10-100× faster traversal for relationship-based checks compared to recursive SQL queries, an about 30-50% reduction in policy evaluation time compared to separate ABAC and ReBAC systems, and near-constant time for most common authorization patterns regardless of organizational size. The ReBAC-ABAC hybrid architecture reduces administrative overhead, achieving an about 85% reduction in time spent propagating policy changes, zero manual steps required when organizational structure changes, and 100% consistency in policy application across the organization. The ReBAC-ABAC hybrid architecture scales efficiently across enterprise deployments, and has been successfully implemented with about 10 million identity nodes, handling about 50 million relationship edges, supporting over about 100,000 authorization decisions per second with caching, and achieving about 99.9th percentile latency under about 50 ms for cached decisions.

FIG. 9 illustrates an example call-flow 900 applicable to any of the systems and methods provided herein. Call flow 900 for a ReBAC-ABAC system may include a policy enforcement point (PEP) 902, a PDP 904, a resolver 906 (e.g., a resolution manager), one or more attribute policy information points (PIPs) 908, and a two-tier cache 910 (e.g., the multi-level caching architecture described above) performing steps 912-930. The process may begin in step 912 with the PEP 902 sending an evaluation request to the PDP 904 that includes, for example, the subject, resource, action, and/or context. In response (step 914), PDP 904 may then call the two-tier cache 910 (e.g., via getDecision) using a key. In step 916, two-tier cache 910 may return a PERMIT or DENY decision to the PDP 904. If the decision is not found in the cache (miss), the PDP 904 may send a resolution request to the resolver 906 to resolve the subject and resource (step 918). The resolver 906 in step 920 may retrieve attributes for the subject and resource (e.g., in parallel) from the one or more attribute PIPs. The resolver 906 may traverse the graph to find the relevant Policy Vertices (step 922) and return a PolicySet and an attribute bag to the PDP (step 924). The PDP 904 may merge the policies and apply a deny-override rule (step 926). The PDP 904 may then store the decision in the two-tier Cache 910 with a TTL value (step 928). Finally, in step 930, the PDP 904 may return the PERMIT or DENY decision to the PEP 902. In this way, call flow 900 may ensure that access control decisions are made efficiently and accurately by leveraging a combination of caching, attribute retrieval, and policy evaluation.

### Example Methods

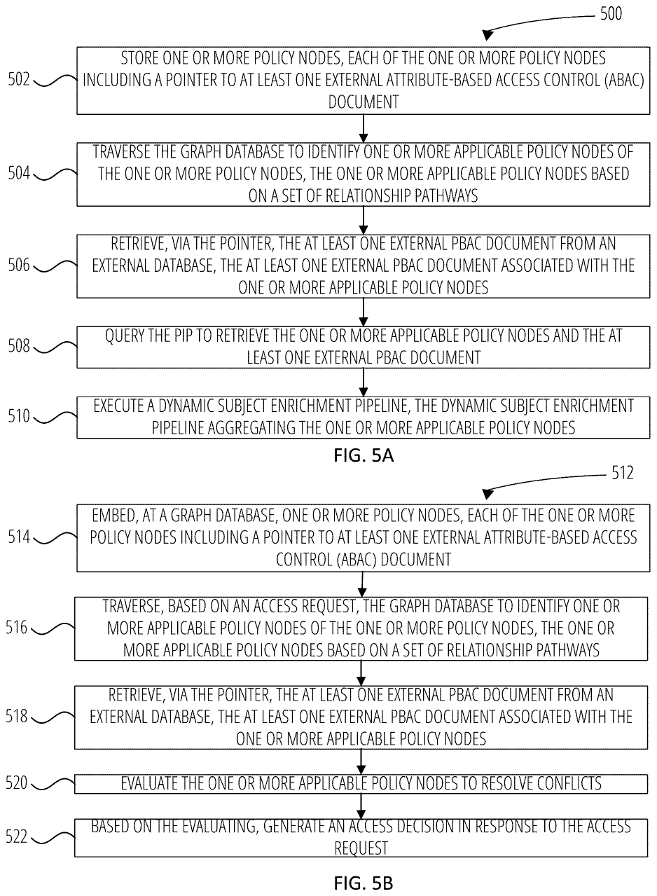

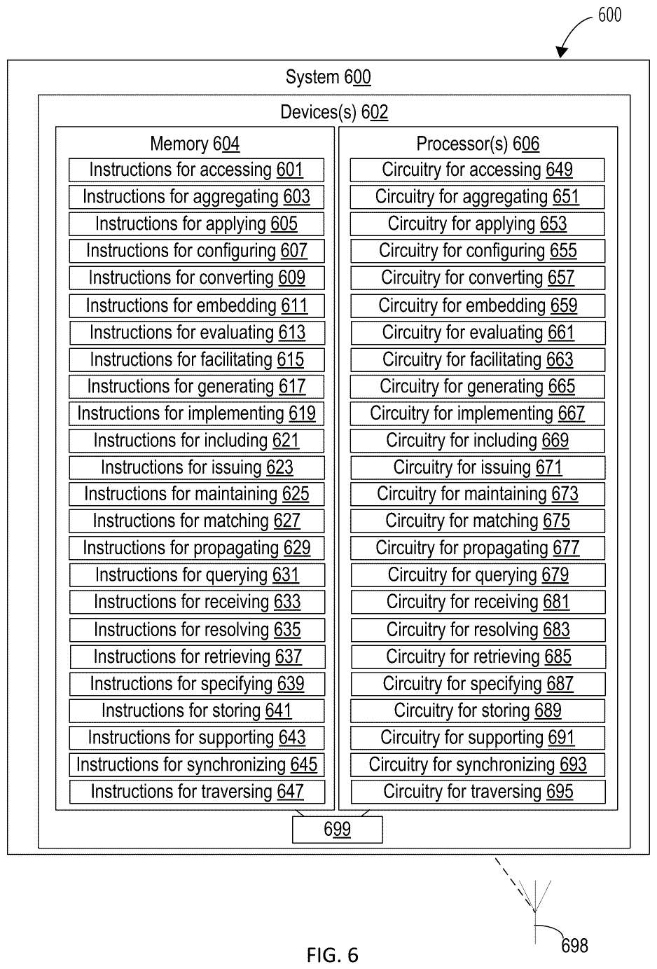

FIG. 5A is a schematic flowchart of an example method 500 for implementing access control by one or more processors, such as the processors of system 600 of FIG. 6.

Method 500 begins at operation 502 with one or more processors storing, via a graph database, one or more policy nodes, each of the one or more policy nodes including a pointer to at least one external ABAC document. In one example, the graph database is configured to store identify nodes, role nodes, group nodes, or some combination therein. In one example, each of the identify nodes, the role nodes, and the group nodes are connected by relationship edges. In one example, the graph database is further configured to store the set of relationship edges, the set of relationship edges configured to facilitate policy inheritance along edges of the graph database.

Method 500 continues to operation 504 with one or more processors traversing, via a resolution manager electronically coupled to the graph database, the graph database to identify one or more applicable policy nodes of the one or more policy nodes, the one or more applicable policy nodes based on a set of relationship edges. In one example, the resolution manager is further configured to maintain a synchronized index of policy-to-graph relationships.

Method 500 continues to operation 506 with one or more processors retrieving, via the pointer, the at least one external ABAC document from an external database, the at least one external ABAC document associated with the one or more applicable policy nodes.

Method 500 continues to operation 508 with one or more processors querying, via a PDP electronically coupled to the resolution manager, the resolution manager to retrieve the one or more applicable policy nodes and the at least one external ABAC document. In one example, the PDP is further configured to receive access requests specifying at least one of a subject, a resource, and an action. In one example, the PDP is further configured to evaluate the one or more applicable policy nodes based on a hierarchical deny-override rule. In one example, the PDP is further configured to issue standardized authorization decisions.

Method 500 continues to operation 510 with one or more processors executing a dynamic subject enrichment pipeline, the dynamic subject enrichment pipeline aggregating the one or more applicable policy nodes. In one example, the dynamic subject enrichment pipeline is configured to evaluate the one or more applicable policy nodes to resolve conflicts. In one example, the dynamic subject enrichment pipeline resolves conflicts between the one or more applicable policy nodes by implementing a default that allows deny decisions to override allow decisions.

Method 500 may optionally continue with one or more processors converting, via a policy language processor electronically coupled to the PDP, policy syntax into executable condition trees, the executable condition trees accessible in response to an authorization request. In one example, the policy language processor supports syntactic sugar constructs. In one example, the policy language processor supports path pattern matching with wildcards and parameter extraction. In one example, the policy language processor supports obligations specifying actions required upon permit decision and deny decisions.

Method 500 may optionally continue with one or more processors implementing a multi level caching architecture, the multi-level caching architecture including a least recently used (LRU) cache configured to facilitate access to frequently evaluated decisions. In one example, the multi-level caching architecture includes a distributed cache configured to facilitate sharing decisions across service nodes. In one example, the multi-level caching architecture includes a set of invalidation mechanisms, the set of invalidation mechanisms triggered by one or more policy changes. In at least one example, the multi-level caching architecture is configured to implement an SWR pattern. In at least one example, the SWR pattern directs the multi-level caching architecture to return a stale value while, in a simultaneous manner, refreshing the LRU cache. In at least one example, the SWR is based on a cache key. In at least one example, the multi-level caching architecture is configured to perform request level caching which includes TTL and ETag validation for IR backed policies.

Method 500 may optionally continue with one or more processors configuring the one or more policy nodes to include inheritance properties, the inheritance properties configured to control propagation direction, override behavior, and conflict resolution.

Method 500 may optionally continue with one or more processors implementing the resolution manager and the PDP on one or more processors, and wherein the at least one external ABAC document includes at least one of version information, conditions expressed in human readable format, and obligations to be fulfilled upon permit decisions or deny decisions.

In one embodiment, method 500, or any embodiment related to it, may be performed by a system, device, apparatus, or architecture, such as the architecture 100 of FIG. 1 or system 600 of FIG. 6, which includes various components operable, configured to, or adapted to perform the method 500. System 600 is described below in further detail.

FIG. 5A is just one example of a method, and other methods including fewer, additional, or alternative operations are contemplated consistent with the disclosure.

FIG. 5B is a schematic flowchart of an example method 512 for implementing access control by one or more processors, such as the processors of system 600 of FIG. 6.

Method 512 begins at operation 514 with one or more processors embedding, at a graph database, one or more policy nodes, each of the one or more policy nodes including a pointer to at least one external ABAC document. In one example, embedding the one or more policy nodes includes associating each policy node with a unique identifier. In one example, embedding the one or more policy nodes includes linking the policy nodes to relevant access control policies stored in an external database.

Method 512 continues to operation 516 with one or more processors traversing, based on an access request, the graph database to identify one or more applicable policy nodes of the one or more policy nodes, the one or more applicable policy nodes based on a set of relationship edges. In one example, traversing includes analyzing the relationship edges to determine the relevance of each policy node to the access request. In one example, traversing includes using a graph traversal algorithm to navigate through the graph database.

Method 512 continues to operation 518 with one or more processors retrieving, via the pointer, the at least one external ABAC document from an external database, the at least one external ABAC document associated with the one or more applicable policy nodes. In one example, retrieving includes accessing the external database over a network. In one example, retrieving includes parsing the ABAC document to extract relevant policy information.

Method 512 continues to operation 520 with one or more processors evaluating the one or more applicable policy nodes to resolve conflicts. In one example, evaluating includes comparing the policies associated with the applicable policy nodes to determine if there are any conflicting rules. In one example, evaluating includes prioritizing certain policies based on predefined criteria.

Method 512 continues to operation 522 with one or more processors, based on the evaluating, generating an access decision in response to the access request. In one example, generating an access decision includes determining whether to allow or deny the access request based on the resolved policies. In one example, generating an access decision includes logging the decision for audit purposes.

Method 512 may optionally continue with one or more processors applying policy inheritance rules to the one or more applicable policy nodes to propagate the one or more applicable policy nodes along the set of relationship edges at the graph database. In one example, applying policy inheritance rules includes updating the graph database to reflect inherited policies.

Method 512 may optionally continue with one or more processors resolving conflicts between the one or more applicable policy nodes by implementing a default that allows deny decisions to override allow decisions. In one example, resolving conflicts includes applying a hierarchy of policy rules to determine the final decision.

Method 512 may optionally continue with one or more processors resolving conflicts based on at least one of a subject, a resource, and an action. In one example, resolving conflicts includes analyzing the attributes of the subject, resource, and action to determine the applicable policy.

In one embodiment, method 512, or any embodiment related to it, may be performed by a system, device, apparatus, or architecture, such as the architecture 100 of FIG. 1 or system 600 of FIG. 6, which includes various components operable, configured to, or adapted to perform the method 512. System 600 is described below in further detail.

FIG. 5B is just one example of a method, and other methods including fewer, additional, or alternative operations are contemplated consistent with the disclosure.

### Example System

FIG. 6 illustrates a schematic diagram of an example system 600. The system 600 may be implemented as part of the enhanced access control described with respect to FIGS. 1-5B.

Components of the system may be implemented at a single location or at multiple locations and may be a supervisory system or may be in communication with a supervisory system by way of a communication pathway. In at least one embodiment, the communication pathway may be a wireless communication pathway, a wired communication pathway, or both, though other types of communication pathway are contemplated.

The device(s) 602 may include a CPU processing system, which may be configured to perform access control procedures, such as those described herein with respect to FIGS. 1-5B, as performed by the system 600. The CPU processing system of the device(s) 602 may include one or more processors 606 electronically coupled to a computer-readable medium/memory 604. The one or more processors 606 and the computer-readable medium/memory 604 may communicate via one or more communication pathways 699. In certain embodiments, the computer-readable medium/memory 604 is configured to store instructions (e.g., computer executable code, YAML instructions) that when executed by the one or more processors 606, cause the one or more processors to perform the method 500 described with respect to FIGS. 5A and 5B, or any embodiment related to it. Reference to a single processor performing a function of system 600 may include one or more processors performing that function of system 600.

In the depicted example, computer-readable medium/memory 604 stores instructions (e.g., executable instructions, YAML instructions) 601 for accessing, instructions 603 for aggregating, instructions 605 for applying, instructions 607 for configuring, instructions 609 for converting, instructions 611 for embedding, instructions 613 for evaluating, instructions 615 for facilitating, instructions 617 for generating, instructions 619 for implementing, instructions 621 for including, instructions 623 for issuing, instructions 625 for maintaining, instructions 627 for matching, instructions 629 for propagating, instructions 631 for querying, instructions 633 for receiving, instructions 635 for resolving, instructions 637 for retrieving, instructions 639 for specifying, instructions 641 for storing, instructions 643 for supporting, instructions 645 for synchronizing, and instructions 647 for traversing. Processing of instructions 601-647 may cause the system 600 to perform method 500 and/or method 512 as described with respect to FIGS. 5A and 5B, or any embodiment related to them.

The one or more processors 606 include circuitry configured to implement (e.g., execute) the instructions stored in the computer-readable medium/memory 604, including circuitry 651 for accessing, circuitry 653 for aggregating, circuitry 655 for applying, circuitry 657 for configuring, circuitry 659 for converting, circuitry 661 for embedding, circuitry 663 for evaluating, circuitry 665 for facilitating, circuitry 667 for generating, circuitry 669 for implementing, circuitry 671 for including, circuitry 673 for issuing, circuitry 675 for maintaining, circuitry 677 for matching, circuitry 679 for propagating, circuitry 681 for querying, circuitry 683 for receiving, circuitry 685 for resolving, circuitry 687 for retrieving, circuitry 689 for specifying, circuitry 691 for storing, circuitry 693 for supporting, circuitry 695 for synchronizing, and circuitry 697 for traversing. Processing with circuitry 651-697 may cause the system 600 to perform method 500 and/or method 512 described with respect to FIGS. 5A and 5B, or any embodiment related to them.

Various components of the system 600 may provide means for performing method 500 and/or method 512 described with respect to FIGS. 5A and 5B, or any embodiment related to them.

The system 600 may include or be substantially coupled to a communication component 698. In the depicted example, the communication component 698 is an antenna capable of communicating with controllers similar to system 600 to perform method 500 and/or method 512 described with respect to FIGS. 5A and 5B, or any embodiment related to them. In additional examples, the communication component 698 may be a bus or a wired connection.

### Example Computer System

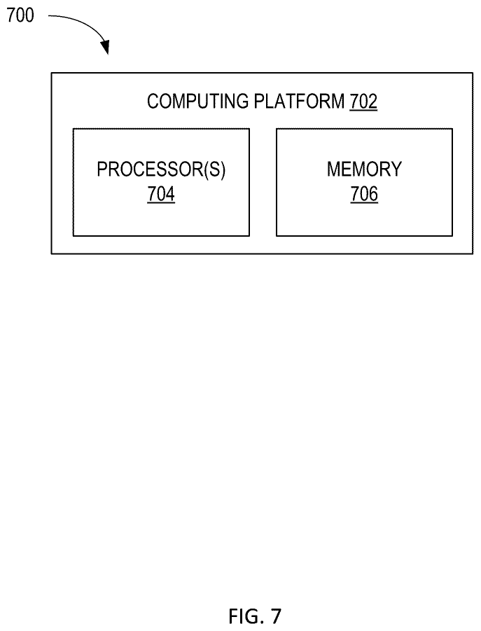

FIG. 7 is an example of a block diagram of a system 700. System 700 can be implemented using one or more modules, shown in block form in the drawings. The one or more modules can be in software or hardware form, or a combination thereof. In some examples, System 700 can be implemented as machine readable instructions for execution on one or more computing platforms 702 (referred to as a computing platform herein), as shown in FIG. 7. The computing platform 702 can include one or more computing devices selected from, for example, a desktop computer, a server, a controller, a blade, a mobile phone, a tablet, a laptop, a personal digital assistant (PDA), and the like.

The computing platform 702 can include a processor 704 and a memory 706. By way of example, the memory 706 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 704 can be implemented, for example, as one or more processor cores. The memory 706 can store machine-readable instructions that can be retrieved and executed by the processor 704 to implement system 700. Each of the processor 704 and the memory 706 can be implemented on a similar or a different computing platform. The computing platform 702 can be implemented in a cloud computing environment (for example, as disclosed herein) and thus on a cloud infrastructure. In such a situation, features of the computing platform 702 can be representative of a single instance of hardware or multiple instances of hardware executing across the multiple of instances (e.g., distributed) of hardware (e.g., computers, routers, memory, processors, or a combination thereof). Alternatively, the computing platform 702 can be implemented on a single dedicated server or workstation.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include one or more service models (e.g., software as a service (Saas, platform as a service (PaaS), and/or infrastructure as a service (IaaS)) and one or more deployment models (e.g., private cloud, community cloud, public cloud, and/or hybrid cloud). A cloud computing environment can be service oriented with a focus on statelessness, low coupling, modularity, and semantic interoperability.

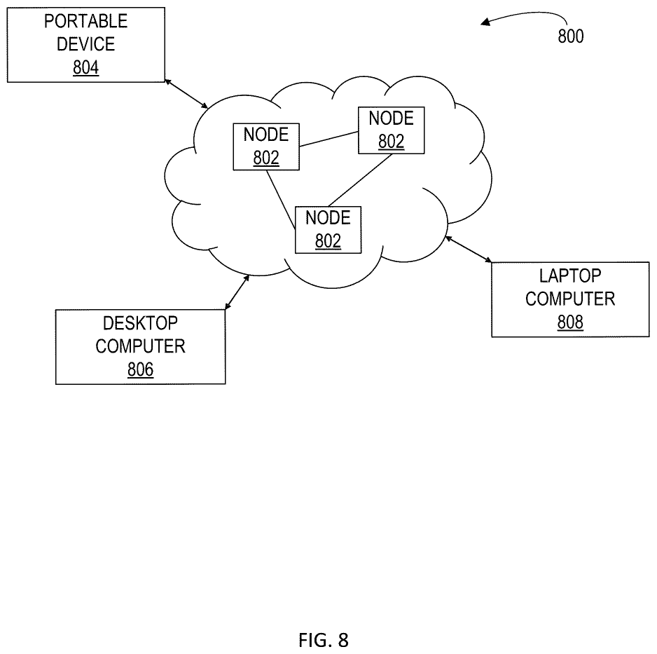

FIG. 8 is an example of a cloud computing environment 800 that can be used for implementing one or more modules and/or systems in accordance with one or more examples, as disclosed herein. Thus, reference can be made to one or more examples of FIGS. 1-7 in the example of FIG. 8. As shown, cloud computing environment 800 can include one or more cloud computing nodes 802 with which local computing devices used by cloud consumers (or users), such as, for example, personal digital assistant (PDA), cellular, or portable device 804, a desktop computer 806, and/or a laptop computer 808, may communicate. The computing nodes 802 can communicate with one another. In some examples, the computing nodes 802 can be grouped (not shown) physically or virtually, in one or more networks, such as Private, Community, Public, or Hybrid clouds, or a combination thereof. This allows the cloud computing environment 800 to offer infrastructure, platforms and/or software as services for which a cloud consumer does not need to maintain resources on a local computing device. The devices 804-808, as shown in FIG. 8, are intended to be illustrative and that computing nodes 802 and cloud computing environment 800 can communicate with any type of computerized device over any type of network and/or network addressable connection (e.g., using a web browser). In some examples, the one or more computing nodes 802 are used for implementing one or more examples disclosed herein relating to root-source identification. Thus, in some examples, the one or more computing nodes can be used to implement modules, platforms, and/or systems, as disclosed herein.

In some examples, the cloud computing environment 800 can provide one or more functional abstraction layers. It is to be understood that the cloud computing environment 800 need not provide all of the one or more functional abstraction layers (and corresponding functions and/or components), as disclosed herein. For example, the cloud computing environment 800 can provide a hardware and software layer that can include hardware and software components. Examples of hardware components include: mainframes; RISC (Reduced Instruction Set Computer) architecture based servers; servers; blade servers; storage devices; and networks and networking components. In some embodiments, software components include network application server software and database software.

In some examples, the cloud computing environment 800 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 800 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 800, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 800 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

### EXAMPLE ASPECTS

Implementation examples are described in the following numbered aspects:

Aspect 1: A system for access control, including: a graph database configured to store one or more policy nodes, each of the one or more policy nodes including a pointer to at least one external ABAC document; a resolution manager electronically coupled to the graph database and configured to: traverse the graph database to identify one or more applicable policy nodes of the one or more policy nodes, the one or more applicable policy nodes based on a set of relationship edges; and retrieve, via the pointer, the at least one external ABAC document from an external database, the at least one external ABAC document associated with the one or more applicable policy nodes; and a PDP electronically coupled to the resolution manager and configured to: query the resolution manager to retrieve the one or more applicable policy nodes and the at least one external ABAC document; and execute a dynamic subject enrichment pipeline, the dynamic subject enrichment pipeline aggregating the one or more applicable policy nodes.

Aspect 2: The system of Aspect 1, further including a policy language processor, the policy language processor electronically coupled to the PDP and configured to convert policy syntax into executable condition trees, the executable condition trees accessible in response to an authorization request.

Aspect 3: The system of Aspect 2, wherein the policy language processor supports syntactic sugar constructs, DSL operators, or both the syntactic sugar constructs and the DSL operators.

Aspect 4: The system of any one of Aspects 2 through 3, wherein the policy language processor supports path pattern matching with wildcards and parameter extraction.

Aspect 5: The system of any one of Aspects 2 through 4, wherein the policy language processor supports obligations specifying actions required upon permit decision and deny decisions.

Aspect 6: The system of any one of Aspects 1 through 5, wherein the graph database is further configured to store identify nodes, role nodes, group nodes, or some combination therein.

Aspect 7: The system of Aspect 6, wherein each of the identify nodes, the role nodes, and the group nodes are connected by relationship edges.

Aspect 8: The system of any one of Aspects 1 through 7, wherein the graph database is further configured to store the set of relationship edges, the set of relationship edges configured to facilitate policy inheritance along pathways of the graph database.

Aspect 9: The system of any one of Aspects 1 through 8, wherein the resolution manager is further configured to maintain a synchronized index of policy-to-graph relationships.

Aspect 10: The system of any one of Aspects 1 through 9, wherein the PDP is further configured to receive access requests specifying at least one of a subject, a resource, and an action.

Aspect 11: The system of any one of Aspects 1 through 10, wherein the PDP is further configured to evaluate the one or more applicable policy nodes based on a hierarchical deny-override rule.

Aspect 12: The system of any one of Aspects 1 through 11, wherein the PDP is further configured to issue standardized authorization decisions.

Aspect 13: The system of any one of Aspects 1 through 12, wherein the one or more applicable policy nodes are one or more direct policy assignments, one or more inherited policy assignments, or both.

Aspect 14: The system of any one of Aspects 1 through 13, further including a multi-level caching architecture, the multi-level caching architecture including an LRU cache configured to facilitate access to frequently evaluated decisions.

Aspect 15: The system of any one of Aspects 1 through 14, wherein the multi-level caching architecture is configured to implement an SWR pattern.

Aspect 16: The system of any one of Aspects 14 through 15, wherein the SWR pattern directs the multi-level caching architecture to return a stale value while, in a simultaneous manner, refreshing the LRU cache.

Aspect 17: The system of any one of Aspects 14 through 16, wherein the SWR is based on a cache key.

Aspect 18: The system of any one of Aspects 1 through 17, further including a multi-level caching architecture, the multi-level caching architecture including a distributed cache configured to facilitate sharing decisions across service nodes.

Aspect 19: The system of any one of Aspects 1 through 18, further including a multi-level caching architecture, the multi-level caching architecture including a set of invalidation mechanisms, the set of invalidation mechanisms triggered by one or more policy changes.

Aspect 20: The system of any one of Aspects 1 through 19, wherein the one or more policy nodes include inheritance properties, the inheritance properties configured to control propagation direction, override behavior, and conflict resolution.

Aspect 21: The system of any one of Aspects 1 through 20, wherein the dynamic subject enrichment pipeline is configured to evaluate the one or more applicable policy nodes to resolve conflicts.

Aspect 22: The system of Aspect 21, wherein the dynamic subject enrichment pipeline resolves conflicts between the one or more applicable policy nodes by implementing a default that allows deny decisions to override allow decisions.

Aspect 23: The system of any one of Aspects 1 through 22, wherein the resolution manager and the PDP are implemented on one or more processors, and wherein the at least one external ABAC document includes at least one of version information, conditions expressed in human-readable format, and obligations to be fulfilled upon permit decisions or deny decisions.

Aspect 24: The system of any one of Aspects 1 through 23, wherein the external database is a Git repository.

Aspect 25: A method for access control implemented on at least one processor, including: embedding, at a graph database, one or more policy nodes, each of the one or more policy nodes including a pointer to at least one external ABAC document; traversing, based on an access request, the graph database to identify one or more applicable policy nodes of the one or more policy nodes, the one or more applicable policy nodes based on a set of relationship edges; retrieving, via the pointer, the at least one external ABAC document from an external database, the at least one external ABAC document associated with the one or more applicable policy nodes; evaluating the one or more applicable policy nodes to resolve conflicts; and based on the evaluating, generating an access decision in response to the access request.

Aspect 26: The method of Aspect 25, further including applying policy inheritance rules to the one or more applicable policy nodes to propagate the one or more applicable policy nodes along the set of relationship edges at the graph database.

Aspect 27: The method of any one of Aspects 25 through 26, further including resolving conflicts between the one or more applicable policy nodes by implementing a default that allows deny decisions to override allow decisions.

Aspect 28: The method of any one of Aspects 25 through 27, wherein the conflicts are resolved based on at least one of a subject, a resource, and an action.

Aspect 29: A non-transitory computer-readable medium for access control having instructions stored thereon, the instructions when executing causing a processor to: embed, at a graph database, one or more policy nodes, each of the one or more policy nodes including a pointer to at least one external ABAC document; traverse, based on an access request, the graph database to identify one or more applicable policy nodes of the one or more policy nodes, the one or more applicable policy nodes based on a set of relationship edges; retrieve, via the pointer, the at least one external ABAC document from an external database, the at least one external ABAC document associated with the one or more applicable policy nodes; evaluate the one or more applicable policy nodes to resolve conflicts; and based on the evaluating, generate an access decision in response to the access request.

Aspect 30: An apparatus or device including a memory comprising executable instructions, and a processor configured to execute the executable instructions and cause the apparatus to perform a method in accordance with any one of Aspects 1-29.

Aspect 31: An apparatus or device, including means for performing a method in accordance with any one of Aspects 1-29.

Aspect 32: A non-transitory computer-readable medium including executable instructions that, when executed by a processor of an apparatus, cause the apparatus to perform a method in accordance with any one of Aspects 1-29.

Aspect 33: A computer program product embodied on a computer-readable storage medium comprising code for performing a method in accordance with any one of Aspects 1-29.

### Additional Considerations

Embodiments of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement embodiments of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or conduct combinations of special purpose hardware and computer instructions.

“Real-time” may refer to the capability of a system or process to respond to inputs or events within a strict period of time, such as immediately or within seconds or milliseconds. In computing and information technology, real-time systems may be designed to process data and provide outputs instantaneously or almost instantaneously, ensuring minimal latency.

The terminology used herein is for the purpose of describing particular embodiments only and is not intended to limit the disclosure. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 5-10% of the indicated number.

While the disclosure has described several exemplary embodiments, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to embodiments of the disclosure without departing from the essential scope thereof. Therefore, it is intended that the disclosure not be limited to the particular embodiments disclosed, or to the best mode contemplated for conducting this disclosure, but that the disclosure will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. This listing of claims will replace all prior versions of claims in the application:

1. A system for access control, comprising:
a graph database configured to store one or more policy nodes, each of the one or more policy nodes including a pointer to at least one external attribute-based access control (ABAC) document;
a resolution manager electronically coupled to the graph database and configured to:
traverse the graph database to identify one or more applicable policy nodes of the one or more policy nodes, the one or more applicable policy nodes based on a set of relationship edges; and
retrieve, via the pointer, the at least one external ABAC document from an external database, the at least one external ABAC document associated with the one or more applicable policy nodes; and
a policy decision point (PDP) electronically coupled to the resolution manager and configured to:
query the resolution manager to retrieve the one or more applicable policy nodes and the at least one external ABAC document; and
execute a dynamic subject enrichment pipeline, the dynamic subject enrichment pipeline aggregating the one or more applicable policy nodes with one or more inherited policy nodes resolved from the set of relationship edges to generate an enriched authorization context for evaluating an access request.

2. The system of claim 1, further comprising a policy language processor, the policy language processor electronically coupled to the PDP and configured to convert policy syntax into executable condition trees, the executable condition trees accessible in response to an authorization request.

3. The system of claim 2, wherein the policy language processor supports syntactic sugar constructs, domain specific language (DSL) operators, or both the syntactic sugar constructs and the DSL operators.

4. The system of claim 2, wherein the policy language processor supports path pattern matching with wildcards and parameter extraction.

5. The system of claim 2, wherein the policy language processor supports obligations specifying actions required upon permit decision and deny decisions.

6. The system of claim 1, wherein the graph database is further configured to store identify nodes, role nodes, group nodes, or some combination therein.

7. The system of claim 6, wherein each of the identify nodes, the role nodes, and the group nodes are connected by relationship edges.

8. The system of claim 1, wherein the graph database is further configured to store the set of relationship edges, the set of relationship edges configured to facilitate policy inheritance along pathways of the graph database.

9. The system of claim 1, wherein the resolution manager is further configured to maintain a synchronized index of policy-to-graph relationships.

10. The system of claim 1, wherein the PDP is further configured to receive access requests specifying at least one of a subject, a resource, and an action.

11. The system of claim 1, wherein the PDP is further configured to evaluate the one or more applicable policy nodes based on a hierarchical deny-override rule.

12. The system of claim 1, wherein the PDP is further configured to issue standardized authorization decisions.

13. The system of claim 1, wherein the one or more applicable policy nodes are one or more direct policy assignments, one or more inherited policy assignments, or both.

14. The system of claim 1, further comprising a multi-level caching architecture, the multi-level caching architecture including a least recently used (LRU) cache configured to facilitate access to frequently evaluated decisions.

15. The system of claim 14, wherein the multi-level caching architecture is configured to implement a stale-while-revalidate (SWR) pattern.

16. The system of claim 15, wherein the SWR pattern directs the multi-level caching architecture to return a stale value while, in a simultaneous manner, refreshing the LRU cache.

17. The system of claim 16, wherein the SWR is based on a cache key.

18. The system of claim 1, further comprising a multi-level caching architecture, the multi-level caching architecture including a distributed cache configured to facilitate sharing decisions across service nodes.

19. The system of claim 1, further comprising a multi-level caching architecture, the multi-level caching architecture including a set of invalidation mechanisms, the set of invalidation mechanisms triggered by one or more policy changes.

20. The system of claim 1, wherein the one or more policy nodes include inheritance properties, the inheritance properties configured to control propagation direction, override behavior, and conflict resolution.

21. The system of claim 1, wherein the dynamic subject enrichment pipeline is configured to evaluate the one or more applicable policy nodes to resolve conflicts.

22. The system of claim 21, wherein the dynamic subject enrichment pipeline resolves conflicts between the one or more applicable policy nodes by implementing a default that allows deny decisions to override allow decisions.

23. The system of claim 1, wherein the resolution manager and the PDP are implemented on one or more processors, and wherein the at least one external ABAC document includes at least one of version information, conditions expressed in human-readable format, and obligations to be fulfilled upon permit decisions or deny decisions.

24. The system of claim 1, wherein the external database is a Git repository.

25. A method for access control implemented on at least one processor, comprising:
embedding, at a graph database, one or more policy nodes, each of the one or more policy nodes including a pointer to at least one external attribute-based access control (ABAC) document;
traversing, based on an access request, the graph database to identify one or more applicable policy nodes of the one or more policy nodes, the one or more applicable policy nodes based on a set of relationship edges;
retrieving, via the pointer, the at least one external ABAC document from an external database, the at least one external ABAC document associated with the one or more applicable policy nodes;
evaluating the one or more applicable policy nodes to resolve conflicts; and
based on the evaluating, generating an access decision in response to the access request.

26. The method of claim 25, further comprising applying policy inheritance rules to the one or more applicable policy nodes to propagate the one or more applicable policy nodes along the set of relationship edges at the graph database.

27. The method of claim 25, further comprising resolving conflicts between the one or more applicable policy nodes by implementing a default that allows deny decisions to override allow decisions.

28. The method of claim 25, wherein the conflicts are resolved based on at least one of a subject, a resource, and an action.

29. A non-transitory computer-readable medium for access control having instructions stored thereon, the instructions when executing causing a processor to:
embed, at a graph database, one or more policy nodes, each of the one or more policy nodes including a pointer to at least one external attribute-based access control (ABAC) document;
traverse, based on an access request, the graph database to identify one or more applicable policy nodes of the one or more policy nodes, the one or more applicable policy nodes based on a set of relationship edges;
retrieve, via the pointer, the at least one external ABAC document from an external database, the at least one external ABAC document associated with the one or more applicable policy nodes;
evaluate the one or more applicable policy nodes to resolve conflicts; and
based on the evaluating, generate an access decision in response to the access request.
